(19) United States
(12) Patent Application Publication
(10) Pub. No.: US 2007/0023631 A1
(43) Pub. Date: Feb. 1, 2007

(54) Parallel sample handling for high-throughput mass spectrometric analysis

(76) Inventors: Zoltan Takats, Budapest (HU); Robert G. Cooks, West Lafayette, IN (US)

Correspondence Address: BRINKS HOFER GILSON & LIONE, P.O. BOX 10395, CHICAGO, IL, 60610, US

(21) Appl. No.: 11/092,104

(22) Filed: Mar. 29, 2005

Related U.S. Application Data
(60) Provisional application No. 60/557,628, filed on Mar. 30, 2004.

(51) Int. Cl. H01J 49/00

(52) U.S. Cl. 250/282; 250/288

(57) ABSTRACT

A system to handle a set of samples for mass spectrometric analysis includes a set of elements that couples to a sample plate containing the set of samples. Each element is integrated with a respective mass analyzer, and includes an ionizer to ionize the respective sample. The set of samples are collected and then ionized simultaneously, and the ionized samples are transferred simultaneously to the respective mass analyzers.

### RELATED APPLICATION

This application claims the benefit of U.S. Provisional Application No. 60/557,628, filed Mar. 30, 2004, the entire contents of which are incorporated herein by reference.

### BACKGROUND

The present invention generally relates to sample handling for mass spectrometry.

Mass spectrometers of various types have been used to identify molecules and to determine their molecular structure by mass analysis. The molecules are ionized and then introduced into the mass spectrometer for mass analysis. Typically, the mass analysis is performed using a “single channel”. That is, a sample introduction system collects a single sample and introduces this sample to a single ion source where the sample is ionized. The ion source is connected to a single mass analyzer, or perhaps to a multiple-stage mass analyzer, which in turn is followed by a single detector and a one channel data acquisition system.

Even though a robotic device may be used to collect the samples from, for example, a 96 well plate, the samples have to be analyzed serially by single channel systems, and, therefore, the throughput capabilities of these systems are quite limited.

Accordingly, there is a need for a sample handling system for mass spectrometers with significantly higher throughput than conventional single channel systems.

### SUMMARY

In general, the present invention is directed to a sample handling system and methods of its operations for performing multichannel analysis of multiple samples. The handling system can be integrated with any type of mass analyzer or any combinations of mass analyzers. Further, the handling system can be integrated with any type of ionizers or any combinations or ionizers.

In one aspect, a system to handle a set of samples for mass spectrometric analysis includes a set of elements that couples to a sample plate containing the set of samples. Each element is integrated with a respective mass analyzer, and includes an ionizer to ionize the respective sample. The set of samples are collected and then ionized simultaneously, and the ionized samples are transferred simultaneously to the respective mass analyzers. The ionization can be by corona discharge or by electrospray ionization. The headspace of the sample can be analyzed. The sample can be subjected to capillary electrophoresis prior to ionization.

Further features and advantages will be apparent from the following description, and from the claims.

### BRIEF DESCRIPTION OF THE DRAWINGS

The drawings are not necessarily to scale, emphasis instead being placed upon illustrating the principles of the invention. Further, like reference numerals refer to the similar parts throughout the figures.

FIG. 1A is a schematic sectional view of a handling system with a set of elements used to perform electrospray ionization (ESI) in accordance with the invention;

FIG. 1B is a schematic sectional view of a handling system with a set of elements used to perform atmospheric pressure chemical ionization (APCI) in accordance with the invention;

FIG. 1C is a schematic sectional view of a handling system with a set of elements used to perform head space corona discharge analysis (HS-CD) in accordance with the invention;

FIG. 2A is a schematic sectional view of an individual element of the set of elements shown in FIG. 1A;

FIG. 2B is a schematic sectional view of an individual element of the set of elements shown in FIG. 1B;

FIG. 2C is a schematic sectional view of an individual element of the set of elements shown in FIG. 1C; and

FIG. 2D is a schematic sectional view of an individual element used to perform capillary electrophoresis (CE) on a large set of samples in parallel prior to their introduction to the corresponding mass analyzers.

### DETAILED DESCRIPTION

Referring now to the drawings, a handling system embodying the principles of the present invention is illustrated therein and designated at 10. As its primary components, the system 10 includes a set of individual electrospray ionization (ESI) elements 12 coupled to respective mass analyzers 14 arranged as an array. Each mass analyzer may function as a mass spectrometer or may be combined as a multiplexed mass spectrometer.

Each of the ESI elements 12 collects a sample from a well in a microtiter plate 16 and performs a set of operations on the sample. The microtiter plate 16 can be a conventional 96 well plate arranged as a 12 by 8 array. The samples may be arranged in sets or groups, such that a group of samples may be collected from the microtiter plate 16 and treated simultaneously by respective ESI elements 12 in a parallel manner. A group may contain a single sample, more than one sample, or all the samples in the microtiter plate 16. The operations performed in each ESI element 12 include but are not limited to standard unit operations in analytical chemistry, such as operations used to prepare samples for analysis by mass spectrometry. These include filtration, automated chemical reactions, such as derivativation, pre-analysis quality control steps, such as absorbance measurements, sample pretreatments, such as buffering, and separation methods including liquid and gas chromatography and capillary electrophoresis. After each sample is ionized, although not necessarily from the solution state, and it can be subjected to mass spectrometry and, optionally, tandem mass spectrometry and ion mobility separation.

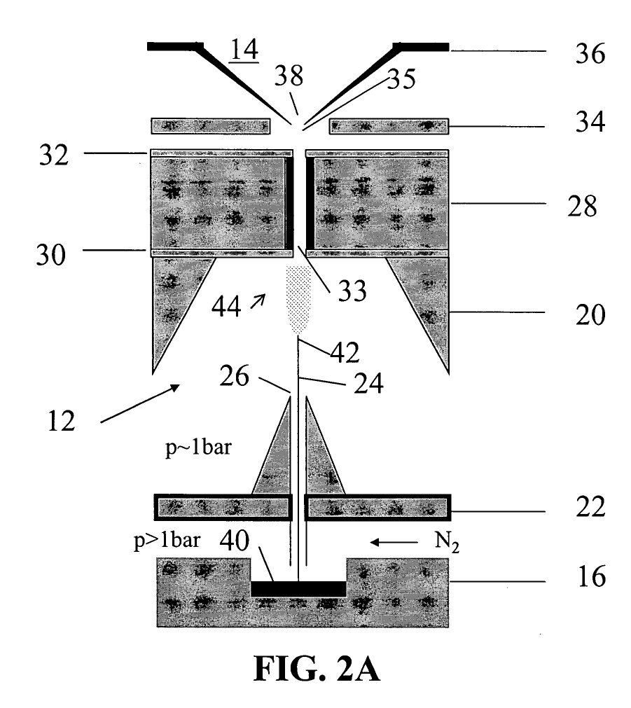

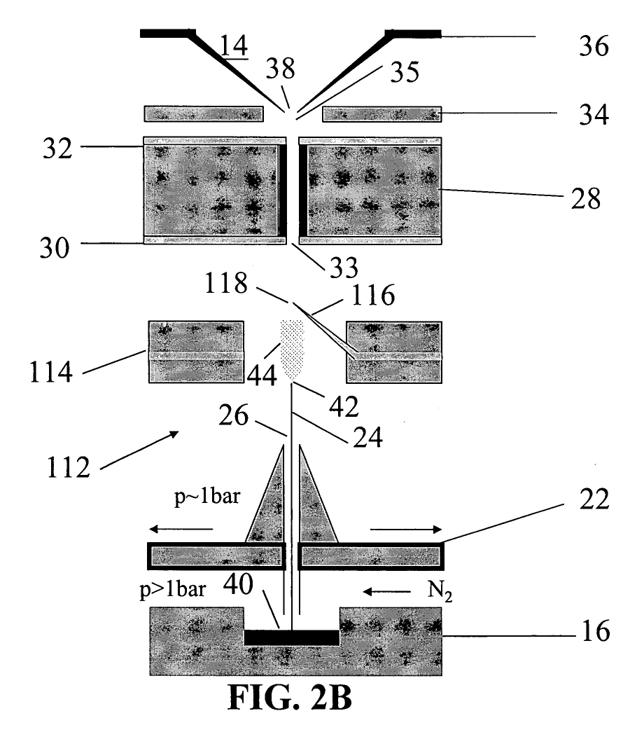

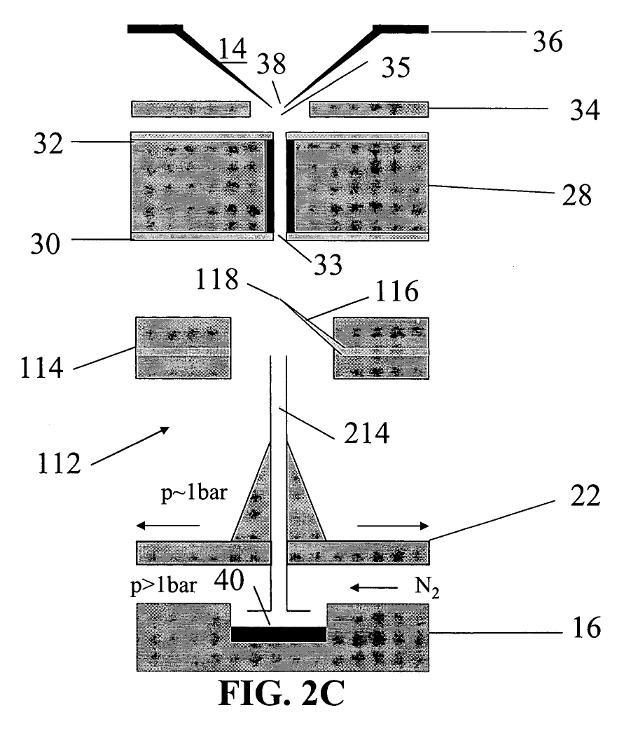

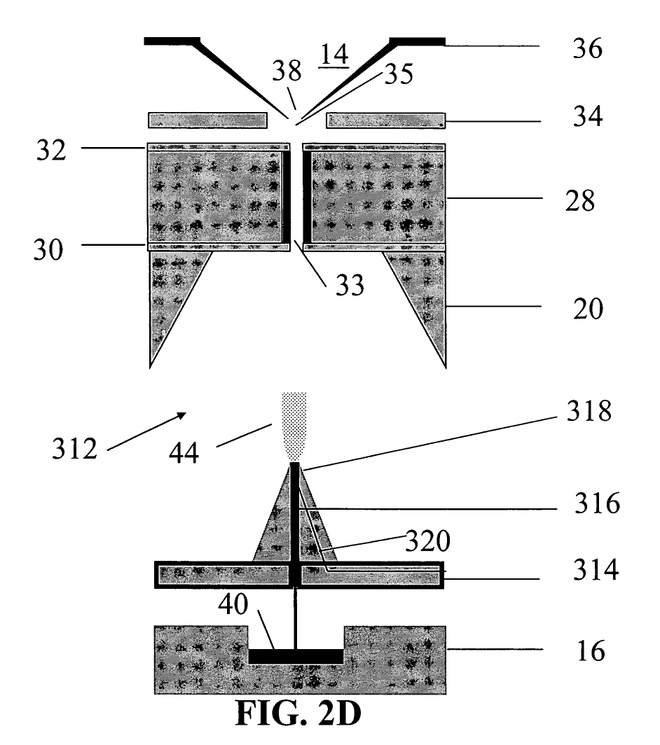

As shown in FIG. 2A, each ESI element 12 includes a shield plate 20, a nebulizer plate 22 with a capillary 24 extending through an aperture 26, a capillary plate 28 with a bottom conductor 30, a top conductor 32 and an aperture 33, a lens plate 34 with an aperture 35, and a skimmer plate 36 with an aperture 38.

When the ESI elements 12 are in use, each well in the microtiter plate 16 contains a sample 40 in solution form, such as a protein, drug, or amino acid. The nebulizer plate 22 couples to the microtiter plate 16 in a sealed manner, so that as a nebulizing gas, such as N₂, is pumped in the region between the microtitier plate 16 and the nebulizer plate 22, this region is pressurized above atmospheric pressure (i.e., >1 bar), while the region on the other side of the nebulizer plate 22 is at about atmospheric pressure (i.e., about 1 bar). Thus, the nebulizer plate 22 acts as a restrictor between the atmospheric region on one side of the nebulizer plate and the higher pressure region between the nebulizer plate 22 and the microtiter plate 16. The capillary 24 extends from the sample 40 through though the aperture 26 of the nebulizer plate 22 and draws the sample 40 to the tip 42 of the capillary 24. In a particular embodiment, each capillary 24 has a diameter of about 254 μm and has a length of about 20 cm.

The bottom conductor 30 of the capillary plate 28 can be any suitable conductive material, such as a metal. A potential difference of about 2 to 5 KV is generated between the tip 42 and the bottom conductor 3o to produce an electrospray 44. The shield plate 20 minimizes cross contamination with other elements on either side of the ESI element 12.

The capillary plate 28 may be heated to desolvate the ions, that is, to separate the solvent molecules from the ions, as the spray sample progresses through the aperture 33 in the capillary plate 28. A voltage in the range between about 0 and 50 v is applied to the top conductor 32 which is made from any suitable conductive material, such as metal. In addition, a voltage in the range between about 0 and 200 V is applied to the lens plate 34 while the skimmer plate 36 is grounded. A vacuum of about 1 to 2 Torrs is maintained, for example, by a two-stage rotary vane pump, in the region between the capillary plate 28 and the skimmer plate 36, with the pressure between the lens plate 34 and the capillary plate 28 at a slightly higher pressure than the region between the lens plate 34 and the skimmer plate 36. A higher vacuum of about 10⁻⁴ Torr is maintained, for example, by a turbomolecular drag pump, on the other side of the skimmer plate 36. After the ions are guided through the capillary plate 26, the lens plate 34 and the skimmer plate 36 focus the ions through the aperture 38, which has a diameter of about 500 μm into the high vacuum side of the mass analyzer 14.

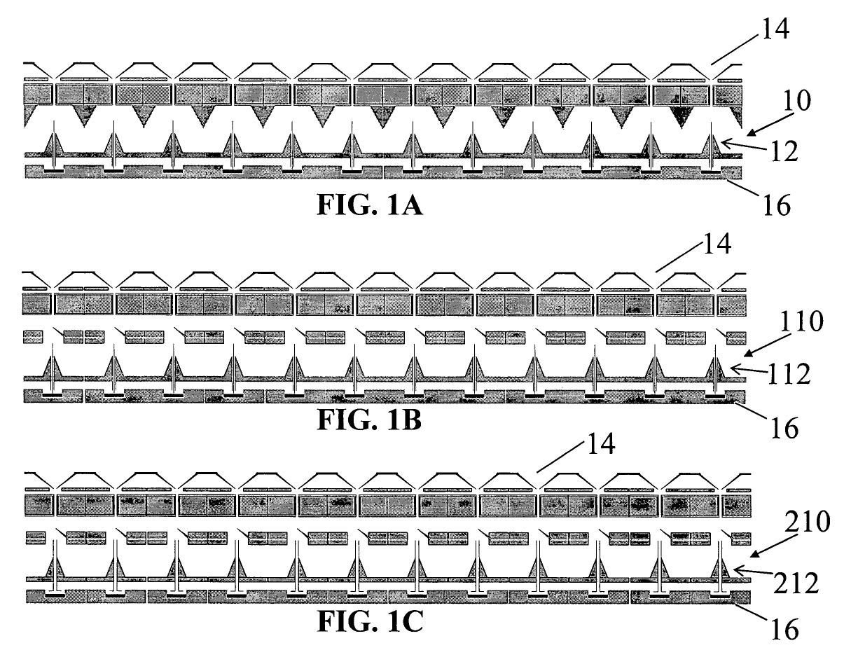

Other implementations are also considered. For example, as shown in FIG. 1B, a sample handling system 110 includes a set of atmospheric pressure ionization (APCI) elements 112, which may also be coupled to respective mass analyzers 14 similar to those shown in FIG. 1A. Although some of the components of the APCI element 112 are similar to those of the ESI element 12 and are identified by like reference numerals, indicating that they perform similar functions, the APCI element 112 includes a plate 114 with a discharge needle 116. As such, a potential of about 2 to 5 KV is generated between the tip 118 of the discharge needle 116 and the conductor 30 of the capillary plate 28, and not between the tip 42 of the capillary 24 and the conductor 30. The potential between the tip 118 and the conductor 30 creates a corona discharge to produce the ionized spray 44. Optionally, the APCI elements 112 can be provided shield plates 20.

In another implementation shown in FIG. 1C, a sample handling system 210 includes a set of headspace analysis elements 212, which may be coupled to respective mass analyzers like those discussed above with reference to FIG. 1A. Referring also to FIG. 2C, the headspace analysis element 212 is similar in many respects to the APCI element 112 shown in FIG. 2B. However, the headspace analysis element 212 includes a sample tube 214 rather than the capillary 34 of the APCI element 112. Rather than extending into the sample, the tube 214 enables sampling the headspace of the sample 40 contained in the microtiter plate 16, so that the gas stream through the tube 214 can be used to transport the sample vapor. The spray 44 is emitted from the tube 214, and is ionized in the same manner as described above with reference to FIG. 2B. The headspace anlaysis elements 212 may or may not include shield plates 20.

In yet another implementation, a capillary electrophoresis element 312 shown in FIG. 2D includes a high voltage supply plate 314 to create the electrospray bias with the conductor 30 of the capillary plate 28. This bias generates the ionized spray 44 as the sample is emitted from a capillary column 316 extending through the high voltage supply plate 314. The supply plate 314 is also provides a sheath liquid 320 to the capillary column 316, since the flow rate of the sample through the column 316 for capillary electrophoresis may be too low for the electrospray process.

A set of capillary electrophoresis elements 312 may be combined to form a handling system coupled to respective mass analyzers 14 like those shown in FIGS. 1A, 1B, and 1C.

Other embodiments are within the scope of the following claims.

What is claimed is:

1. A method to handle a set of samples for mass spectrometric analysis comprising:
collecting the set of samples simultaneously;
ionizing each sample simultaneously with a set of ionizers; and
transferring the ionized samples simultaneously to a set of mass analyzers.

2. The method of claim 1 wherein the set of ionizers is a set of electrospray ionization ionizers.

3. The method of claim 2 further comprising nebulizing the sample and wherein nebulization is assisted by a nebulizing gas.

4. The method of claim 2 wherein the ionizing produces an ionized spray at one end of a capillary with the other extending to a respective sample.

5. The method of claim 1 wherein the set of ionizers is a set of atmospheric pressure ionization ionizers.

6. The method of claim 5 wherein the ionization is by corona discharge.

7. The method of claim 5 further comprising nebulizing the sample and wherein nebulization is assisted by a nebulizing gas.

8. The method of claim 1 wherein the headspace of the sample is analyzed.

9. The method of claim 8 wherein the ionization is by corona discharge.

10. The method of claim 1 wherein the sample is subjected to capillary electrophoresis prior to ionization.

11. A system to handle a set of samples for mass spectrometric analysis comprising:
a set of elements that couples to a sample plate containing the set of samples, each element being integrated with a respective mass analyzer, each element including an ionizer to ionize the respective sample, the set of samples being collected and ionized simultaneously, the ionized samples being transferred simultaneously to the respective mass analyzers.

12. The system of claim 11 wherein the ionizer is an electrospray ionization ionizer.

13. The system of claim 11 wherein each element includes a capillary with one end extending to the sample and another end where the ionization produces an ionized spray.

14. The system of claim 11 wherein the ionizer is an atmospheric pressure ionizer.

15. The system of claim 14 wherein the ionization is by corona discharge.

16. The system of claim 11 wherein the headspace of the sample is analyzed.

17. The system of claim 16 wherein the ionization is by corona discharge.

18. The system of claim 11 wherein the sample is subjected to capillary electrophoresis prior to ionization.
